(19) United States
(12) Patent Application Publication
(10) Pub. No.: US 2013/0010885 A1
(43) Pub. Date: Jan. 10, 2013

(54) MULTIPLE-INPUT MULTIPLE-OUTPUT WIRELESS COMMUNICATION APPARATUS AND METHOD

(75) Inventor: Min Hoon Kim, Gyunggi-do (KR)

(73) Assignee: SAMSUNG ELECTRO-MECHANICS CO., LTD., Gyunggi-do (KR)

(21) Appl. No.: 13/315,826

(22) Filed: Dec. 9, 2011

(30) Foreign Application Priority Data
Jul. 7, 2011 (KR) 1020110067496

(51) Int. Cl. H04B 7/02

(52) U.S. Cl. 375/267

(57) ABSTRACT

Disclosed herein is a multiple-input multiple-output (MIMO) wireless communication apparatus including: a plurality of radio frequency (RF) modules each processing RF signals input; a plurality of local area communication modules processing a local area communication signal input; a plurality of switches; and a control block determining whether there is an idle RF module in the plurality of RF modules at the time of the MIMO mode operation and switching a corresponding switch so that the local area communication module operating in the MIMO mode and a corresponding RF antenna corresponding to the idle RF module are connected to each other. Therefore, the MIMO mode is implemented without adding the local area communication dedicated antenna, thereby making it possible to maximize space utilization and reduce a cost.

### CROSS REFERENCE TO RELATED APPLICATION

This application claims the benefit of Korean Patent Application No. 10-2011-0067496, filed on Jul. 7, 2011, entitled “Multiple-Input Multiple-Output Wireless Communication Apparatus and Method thereof”, which is hereby incorporated by reference in its entirety into this application.

### BACKGROUND OF THE INVENTION

1. Technical Field

The present invention relates to a multiple-input multiple-output wireless communication apparatus and method.

2. Description of the Related Art

The demand for a wireless communication system has gradually increased for decades. During this period, particularly in a cellular and wireless local area network (WLAN) communication system field, several technical developments have been made.

Particularly, in the WLAN typified by 802.11, a 1×1 system performing transmission using a single antenna has been currently used widely.

However, in accordance with an increase in the kinds of signals that are transmitted and received, a gradual increase in data capacity, and a continuous increase in the number of users using high capacity data, data traffic has become important issue in a wireless network.

In order to satisfy the request of users, transmission and reception of high capacity data at a high speed as well as an increase in data transmitting and receiving capacity have been demanded.

One method handling this problem is to use a multiple-input multiple-output (MIMO) wireless communication system capable of providing an increased data rate.

This system may transmit and receive more data by using a plurality of antennas in both of a transmitter and a receiver.

Different data signals are transmitted from the transmitter by the plurality of antennas, the signals of individual antennas are subjected to independent fading, and the transmitted data signals are distinguished by performing appropriate signal processing using independent fading in the receiver.

The MIMO wireless communication system implementing the above-mentioned operation uses multiple antennas, thereby increasing a data transmission amount without increasing a frequency area used by the system.

That is, the numbers of transmitting and receiving antennas are simultaneously increased, such that channel capacity is increased, thereby making it possible to transmit more data. Therefore, the MIMO communication scheme has been regarded as a candidate for a fixed wireless access (FWA) technology for an ultra-high multimedia communication service.

The MIMO wireless communication apparatus and method according to the prior art requires a plurality of WLAN dedicated antennas for WLAN communication in order to implement the MIMO.

However, in the case of a small-sized terminal such as a cellular phone, installation of the plurality of WLAN dedicated antennas only for WLAN communication has a spatial limitation and causes an increase in a cost required for additionally installing the WLAN dedicated antennas.

### SUMMARY OF THE INVENTION

The present invention has been made in an effort to provide a multiple-input multiple-output (MIMO) wireless communication apparatus and method capable of improving local area wireless communication performance by implementing MIMO of a local area communication module using previously installed antennas without adding local area communication dedicated antennas.

According to a first preferred embodiment of the present invention, there is provided a multiple-input multiple-output (MIMO) wireless communication apparatus including: a plurality of radio frequency (RF) modules each processing RF signals input through a corresponding RF antenna of a plurality of RF antennas; a plurality of local area communication modules processing a local area communication signal input through a local area communication dedicated antenna and processing local area communication signals input through the plurality of RF antennas at the time of an MIMO mode operation; a plurality of switches switched so that the plurality of RF modules and a corresponding RF antenna are connected to or separated from each other and the local area communication module operating at the time of the MIMO mode operation and a corresponding RF antenna are connected to or separated from each other; and a control block determining whether there is an idle RF module in the plurality of RF modules at the time of the MIMO mode operation and switching a corresponding switch so that the local area communication module operating in the MIMO mode and a corresponding RF antenna corresponding to the idle RF module are connected to each other.

The plurality of RF antennas may include: a first RF antenna connected to a corresponding RF module of the plurality of RF antennas or connected to the local area communication module operating in the MIMO mode among the plurality of local area communication modules; and a second RF antenna connected to a corresponding RF module of the plurality of RF antennas or connected to the local area communication module operating in the MIMO mode among the plurality of local area communication modules.

The plurality of RF modules may include: a first RF module processing a first RF signal input through a corresponding RF antenna of the plurality of RF antennas according to a first RF communication scheme; and a second RF module processing a second RF signal input through a corresponding RF antenna of the plurality of RF antennas according to a second RF communication scheme.

The plurality of local area communication modules may include: a first local area communication module processing a first local area communication signal input through the local area communication dedicated antenna according to a first local area communication scheme; a second local area communication module processing a second local area communication signal input through the local area communication dedicated antenna according to a second local area communication scheme; and a third local area communication module processing a third local area communication signal input through a corresponding RF antenna of the plurality of RF antennas connected thereto by a plurality of switches according to a control of the control block according to a third local area communication scheme.

The first to third local area communication modules may be any one of a wireless local area network (WLAN) communication module and a Bluetooth communication module.

The MIMO wireless communication apparatus may further include a local area communication control module controlling each of the first and second local area communication modules so as to be operated according to a corresponding local area communication signal received through the local area communication dedicated antenna and controlling the third local area communication module so as to be operated in the MIMO mode according to the third local area communication signal received through a corresponding RF antenna of the plurality of RF antennas.

The local area communication control module may control a switch (SW) for local area communication so that the local area communication dedicated antenna is connected to a corresponding local area communication module according to a communication scheme of a corresponding local area communication signal received through the local area communication dedicated antenna.

The MIMO wireless communication apparatus may further include a first band pass filter (BPF) installed between the first local area communication module and the local area communication dedicated antenna or between the second local area communication module and the local area communication dedicated antenna and filtering the first local area communication signal or the second local area communication signal received through the local area communication dedicated antenna so as to have a frequency band used in a corresponding local area communication module; a second BPF installed between the third local area communication module and one of the plurality of RF antennas and filtering the third local area communication signal received through a corresponding RF antenna so as to have a frequency band used in the third local area communication module; a third BPF installed between the third local area communication module and the other of the plurality of RF antennas and filtering the third local area communication signal received through a corresponding RF antenna so as to have a frequency band used in the third local area communication module; and a switch (SW) for local area communication performing the switching so that the local area communication dedicated antenna is connected to the first local area communication module or the second local area communication module according to a control of the local area communication control module.

The plurality of switches may include: a first switch performing the switching so that one of the plurality of RF antennas is connected to a corresponding RF module of the plurality of RF modules or the local area communication module operating in the MIMO mode among the plurality of local area communication modules according to a control of the control block; and a second switch perfuming the switching so that the other of the plurality of RF antennas is connected to a corresponding RF module of the plurality of RF modules or the local area communication module operating in the MIMO mode among the plurality of local area communication modules according to a control of the control block.

The control block may determine whether there is an idle RF module in the plurality of RF modules when a MIMO mode operation signal is input and controls the first and second switches so that the RF antenna corresponding to the idle RF module is connected to the local area communication module operating in the MIMO mode among the plurality of local area communication modules.

The MIMO wireless communication apparatus may further include a plurality of antenna tuners having one ends each connected to the plurality of RF antennas and the other ends each connected to the plurality of switches, each tuning a frequency of the corresponding RF antenna connected to the local area communication module operating in the MIMO mode so as to be in a frequency band used in the local area communication module operating in the MIMO mode according to a control of the control block when any one of the plurality of RF antennas is connected to the local area communication module operating in the MIMO mode among the plurality of local area communication modules.

The plurality of antenna tuners may include: a first antenna tuner tuning a frequency of one of corresponding RF antennas connected to the local area communication module operating in the MIMO mode among the plurality of local area communication modules so as to be in a frequency band used in the local area communication module operating in the MIMO mode; and a second antenna tuner tuning a frequency of the other of corresponding RF antennas connected to the local area communication module operating in the MIMO mode among the plurality of local area communication modules so as to be in a frequency band used in the local area communication module operating in the MIMO mode.

The control block may control the first antenna tuner to tune the frequency of one of the corresponding RF antennas connected to the local area communication module operating in the MIMO mode among the plurality of local area communication modules so as to be in the frequency band used in the local area communication module operating in the MIMO mode and control the second antenna tuner to tune the frequency of the other of the corresponding RF antennas connected to the local area communication module operating in the MIMO mode among the plurality of local area communication modules so as to be in the frequency band used in the local area communication module operating in the MIMO mode.

According to a second preferred embodiment of the present invention, there is provided a MIMO wireless communication method including: (A) determining whether there is an idle RF module in a plurality of RF modules when a MIMO mode operation signal is input; (B) switching a corresponding switch so that a corresponding RF antenna corresponding to the idle RF module and a local area communication module operating in a MIMO mode are connected to each other when there is the idle RF module; and (C) performing local area communication through the local area communication module operating in the MIMO mode by receiving a corresponding local area communication signal from the switched corresponding RF antenna.

The MIMO wireless communication method may further include (D) stopping or delaying an operation of any one of the plurality of RF modules when it is determined that there is no idle RF module in the plurality of RF module in step (A).

The MIMO wireless communication method may further include, after step (D), (E) determining whether there is a RF module re-operation signal when a MIMO mode end signal is input, separating the local area communication module operating in the MIMO mode and a corresponding RF antenna from each other, and re-switching a corresponding switch so that the corresponding RF antenna and the corresponding RF module are connected to each other when there is the RF module re-operation signal; and (F) performing RF communication through the corresponding RF module by receiving a corresponding RF communication signal from the re-switched corresponding RF antenna.

### BRIEF DESCRIPTION OF THE DRAWINGS

FIG. 1 is a block diagram of a multiple-input multiple-output (MIMO) wireless communication apparatus according to a preferred embodiment of the present invention;

FIG. 2 is a block diagram of a MIMO wireless communication apparatus according to another preferred embodiment of the present invention; and

FIG. 3 is a flow chart showing a MIMO wireless communication method according to a preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

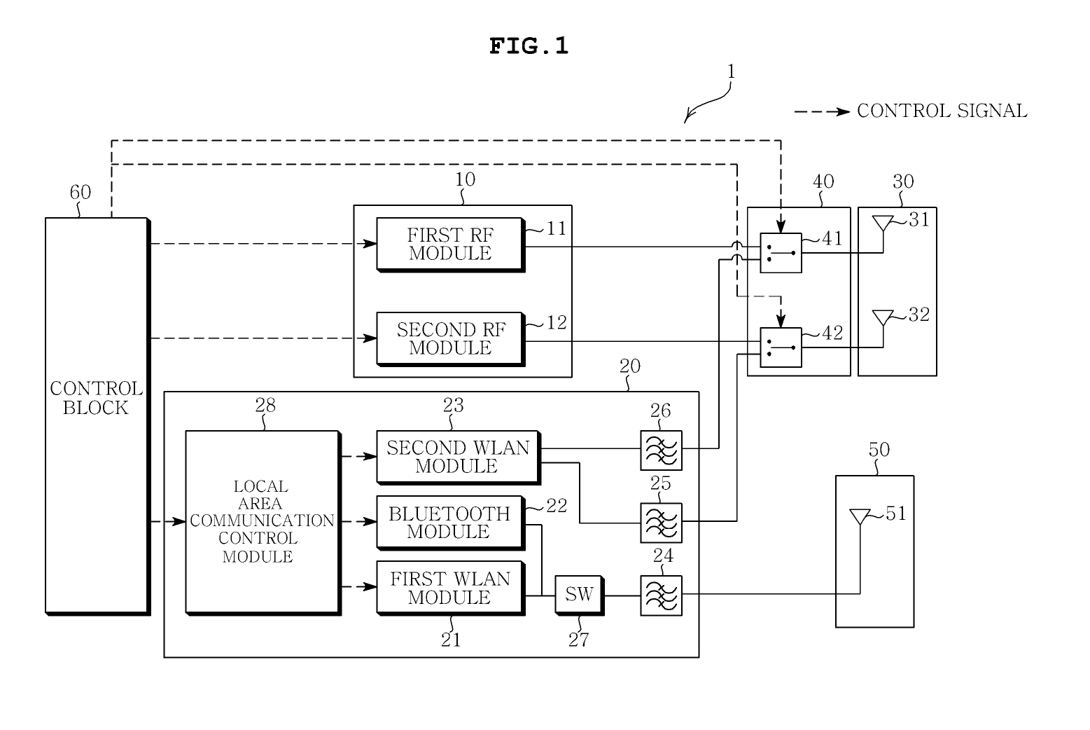

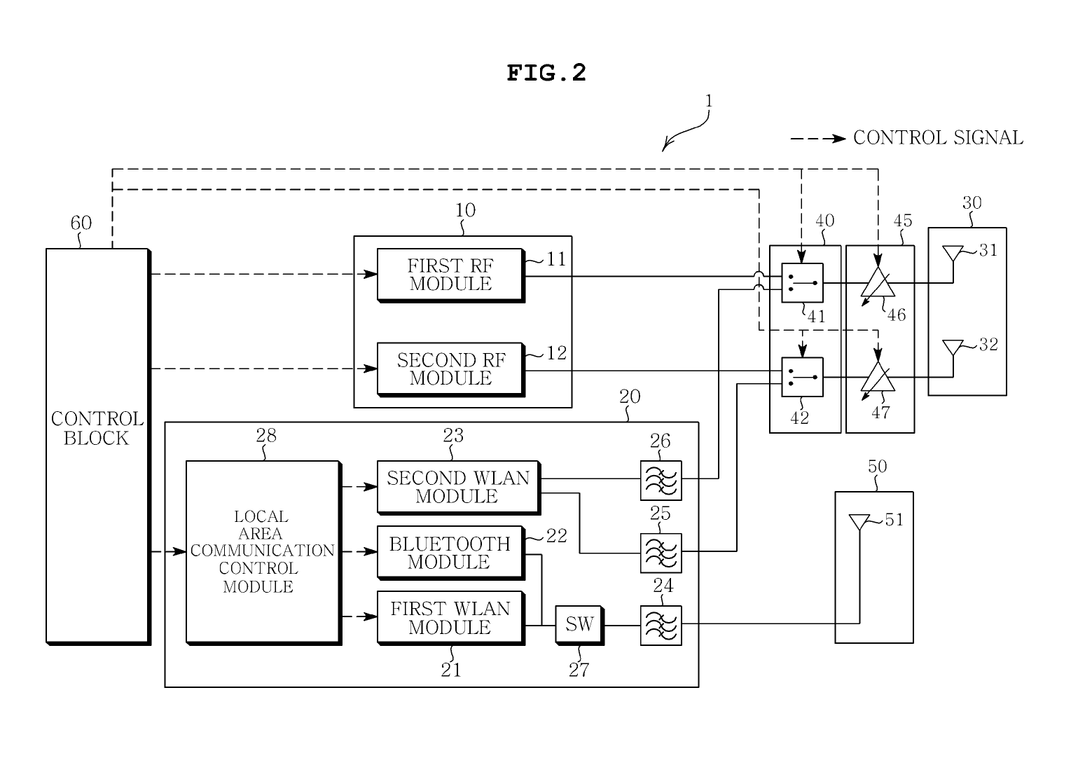

FIG. 1 is a block diagram of a multiple-input multiple-output (MIMO) wireless communication apparatus according to a preferred embodiment of the present invention; and FIG. 2 is a block diagram of a MIMO wireless communication apparatus according to another preferred embodiment of the present invention.

Referring to FIG. 1, a MIMO wireless communication apparatus 1 according to a preferred embodiment of the present invention is configured to include a radio frequency (RF) block 10, a local area communication block 20, a RF antenna block 30, a switch block 40, a local area communication dedicated antenna block 50, and a control block 60.

The RF block 10 is configured of a plurality of RF modules each processing RF signals input through a corresponding RF antenna of a plurality of RF antennas 31 and 32.

For example, the plurality of RF modules according to the preferred embodiment includes a first RF module 11 processing a first RF signal input through a corresponding RF antenna of the plurality of RF antennas according to a first RF communication scheme and a second RF module 12 processing a second RF signal input through a corresponding RF antenna of the plurality of RF antennas according to a second RF communication scheme.

Here, each of the plurality of RF antennas 31 and 32 configuring the RF antenna block 30 is installed to correspond to the plurality of RF modules 11 and 12 of the RF block 10. That is, the first RF antenna 31 corresponds to the first RF module 11, and the second RF antenna 32 corresponds to the second RF module 12.

As the first and second RF modules 11 and 12, various communication modules including, for example, a global system for mobile communication GSM) module using a frequency band of 850 MHz to 1.9 GHz, a global positioning system (GPS) module using a frequency band of 1.2 GHz to 1.5 GHz, a FM module and a long term evolution (LTE) module using a frequency band of 88 MHz to 108 MHz, and the like, may be used.

The local area communication block 20 is configured of a plurality of local area communication modules each processing local area communication signals input through the plurality of RF antennas 31 and 32 or a local area communication dedicated antenna 51.

The local area communication module is generally divided into 802.11a/b/g/n, and the like, according to a transmission speed and a technical specification. Among them, 802.11n, which has a data transmission speed of 300 Mbps or more, may support a MIMO mode and allow local area communication to be performed at a more rapid transmission speed and in a wider area at the time of operation in the MIMO mode.

According to the preferred embodiment of the present invention, at least one of the plurality of local area communication modules 21, 22, and 23 includes a local area communication module operating in the MIMO mode.

For example, the plurality of local area communication module according to the preferred embodiment of the present invention includes a first local area communication module 21 processing a first local area communication signal input through the local area communication dedicated antenna 51 according to a first local area communication scheme, a second local area communication module 22 processing a second local area communication signal input through the local area communication dedicated antenna 51 according to a second local area communication scheme, and a third local area communication module 23 processing a third local area communication signal input through a corresponding RF antenna of the plurality of RF antennas 31 and 32 connected thereto by a plurality of switches 41 and 42 according to a control of the control block 60 according to a third local area communication scheme.

Here, the first and second local area communication modules 21 and 22 process corresponding local area communication signals (for example, the first and second local area communication signals) input through the local area communication dedicated antenna 51 according to a corresponding local area communication scheme, and the third local area communication module 23 implements the MIMO mode using the plurality of previously installed RF antennas 31 and 32 without installing a separate local area communication dedicated antenna to thereby process the local area communication signal (for example, the third communication signal) input through the plurality of RF antennas 31 and 32 according to a corresponding local area communication scheme. That is, according to the preferred embodiment of the present invention, the third local area communication module 23 is operated in the MIMO mode.

The MIMO mode of the third local area communication module 23 uses a maximum ratio combining method at the time of reception of the local area communication signal. Therefore, even though incomplete signals are received through the RF antennas 31 and 32, which are modules other than the third local area communication module 23, the entire received signal to noise ratio (SNR) is more excellent as compared to a case in which only the local area communication dedicated antenna 51 is singly used.

In addition, the MIMO mode of the third local area communication module 23 uses an unequal modulation (UEQM) method at the time of transmission of the local area communication signal. Therefore, modulation is performed at a low data rate in the RF antennas 31 and 32, which are modules other than the third local area communication module 23, and modulation is performed at a high data rate in the local area communication dedicated antenna 51, thereby improving the entire transmission rate as compared to a case in which only the local area communication dedicated antenna 51 is singly used.

As the first to third local area communication modules 21 to 23 as described above, various local area communication modules such as, for example, a wireless local area network (WLAN) communication module, a Bluetooth communication module, and the like, may be used.

In addition, the local area communication block 20 further includes a first band pass filter (BPF) 24 corresponding to the first local area communication module 21, a second BPF 25 corresponding to the second local area communication module 22, a third BPF 26 corresponding to the third local area communication module 23, a switch (SW) 27 for local area communication, and a local area communication control module 28 generally controlling the local area communication block 20.

The first BPF 24 is installed between the first local area communication module 21 and the local area communication dedicated antenna 51 or between the second local area communication module 22 and the local area communication dedicated antenna 51 and filters the first local area communication signal or the second local area communication signal received through the local area communication dedicated antenna 51 so as to have a frequency band used in a corresponding local area communication module.

The second BPF 25 is installed between the third local area communication module 23 and one (for example, the second RF antenna 32) of the plurality of RF antennas 31 and 32 and filters the third local area communication signal received through a corresponding RF antenna so as to have a frequency band used in the third local area communication module 23.

The third BPF 26 is installed between the third local area communication module 23 and the other (for example, the first RF antenna 32) of the plurality of RF antennas 31 and 32 and filters the third local area communication signal received through a corresponding RF antenna so as to have a frequency band used in the third local area communication module 23.

The switch (SW) 27 for local area communication performs switching so that the local area communication dedicated antenna 51 is connected to the first local area communication module 21 or the second local area communication module 22 according to a control of a local area communication control module 28 to be described below

The local area communication control module 28 performs a control so that the first local area communication module 21 and the second local area communication module 22 operate according to the first local area communication signal and the second local area communication signal received through the local area communication dedicated antenna 51, and performs a control so that the third local area communication module 23 operates in the MIMO mode according to the third local area communication signal received through a corresponding RF antenna of the plurality of RF antennas 31 and 32.

In addition, the local area communication control module 28 controls the switch (SW) 27 for local area communication so that the local area communication dedicated antenna 51 is connected to a corresponding local area communication module (the first local area communication module 21 or the second local area communication module 22) according to a communication scheme of the first and second local area communication signals received through the local area communication dedicated antenna 51.

The switch block 40 is configured of a plurality of switches each installed at one ends of the plurality of RF antennas 31 and 32 and performing the switching so that the plurality of RF antennas 31 and 32 are connected to the RF block 10 or the local area communication block 20 according to a control of the control block 60.

More specifically, the plurality of switches include a first switch 41 performing the switching so that one (for example, the first RF antenna 31) of the plurality of RF antennas is connected to a corresponding RF module (for example, the first RF module 11) of the plurality of RF modules or the local area communication module (for example, the third local area communication module 23) operating in the MIMO mode among the plurality of local area communication modules according to a control of a control block 60 to be described below and a second switch 42 performing the switching so that the other (for example, the second RF antenna 32) of the plurality of RF antennas is connected to a corresponding RF module (for example, the second RF module 12) of the plurality of RF modules or the local area communication module (for example, the third local area communication module 23) operating in the MIMO mode among the plurality of local area communication modules according to a control of a control block 60 to be described below, as shown in FIG. 1.

As the first and second switches 41 and 42, for example, a single pole double throw (SPDT) type of switch switching a dual band may be used.

The local area communication dedicated antenna block 50 may be made of a plurality of local area communication dedicated antennas each corresponding to the plurality of local area communication modules 21, 22, and 23 of the local area communication block 20.

The local area communication dedicated antenna block 50 according to the preferred embodiment of the present invention includes a single local area communication dedicated antenna 51 connected to the first local area communication module 21 or the second local area communication module 22 according to the switching of the switch 27 for local area communication, as shown in FIG. 1.

The control block 60 generally controls the MIMO wireless communication apparatus 1 according to the preferred embodiment of the present invention. When a MIMO mode operation signal is input, the control block 60 determines whether there is an idle RF module in the plurality of RF modules 11 and 12 and controls a corresponding switch 41 or 42 so that the RF antenna 31 or 32 corresponding to the idle RF module of the plurality of RF modules 11 and 12 is connected to the local area communication module (for example, the third local area communication module 23) operating in the MIMO mode among the plurality of local area communication modules 21 to 23.

For example, when the first RF module 11 of the plurality of RF modules 11 and 12 is in an idle state, the control block 60 controls the first switch 41 so that the first RF antenna 31 corresponding to the first RF module 11 is connected to the local area communication module (for example, the third local area communication module 23) operating in the MIMO mode among the plurality of local area communication modules 21 to 23.

Likewise, when the second RF module 12 of the plurality of RF modules 11 and 12 is in an idle state, the control block 60 controls the second switch 42 so that the second RF antenna 32 corresponding to the second RF module 12 is connected to the local area communication module (for example, the third local area communication module 23) operating in the MIMO mode among the plurality of local area communication modules 21 to 23.

Meanwhile, a MIMO wireless communication apparatus 2 according to another preferred embodiment of the present invention further includes an antenna tuner block 45 provided between the RF antenna block 30 and the switch block 40 and configured of a plurality of antenna tuners, as shown in FIG. 2.

The MIMO wireless communication apparatus 2 shown in FIG. 2 is the same as the MIMO wireless communication apparatus 1 shown in FIG. 1 except for the antenna tuner block 45. Therefore, a detailed description of the same components will be replaced with the above-mentioned description.

The antenna tuner block 45 may include a plurality of antenna tuners 46 and 47 having one ends each connected to the plurality of RF antennas 31 and 32 and the other ends each connected to the plurality of switches 41 and 42 and each tuning a frequency of a corresponding RF antenna connected to the local area communication module operating in the MIMO mode among the plurality of local area communication modules 21 to 23 so as to be in a frequency band used in the local area communication module operating in the MIMO mode according to a control of the control block 60 when any one of the plurality of RF antennas 31 and 32 is connected to the local area communication module operating in the MIMO mode.

More specifically, the antenna tuner block 45 includes a first antenna tuner 46 tuning a frequency of one (for example, the first RF antenna 31) of corresponding RF antennas connected to the local area communication module operating in the MIMO mode among the plurality of local area communication modules 21 to 23 so as to be in a frequency band used in the local area communication module (for example, the third local area communication module 23) operating in the MIMO mode and a second antenna tuner 47 tuning a frequency of the other (for example, the second RF antenna 32) of corresponding RF antennas connected to the local area communication module operating in the MIMO mode among the plurality of local area communication modules 21 to 23 so as to be in a frequency band used in the local area communication module (for example, the third local area communication module 23) operating in the MIMO mode.

Here, the control block 60 controls the first antenna tuner 46 to tune the frequency of one (for example, the first RF antenna 31) of the corresponding RF antennas connected to the local area communication module operating in the MIMO mode among the plurality of local area communication modules 21 to 23 so as to be in the frequency band used in the local area communication module (for example, the third local area communication module 23) operating in the MIMO mode.

In addition, the control block 60 controls the second antenna tuner 47 to tune the frequency of the other (for example, the second RF antenna 32) of the corresponding RF antennas connected to the local area communication module operating in the MIMO mode among the plurality of local area communication modules 21 to 23 so as to be in the frequency band used in the local area communication module (for example, the third local area communication module 23) operating in the MIMO mode.

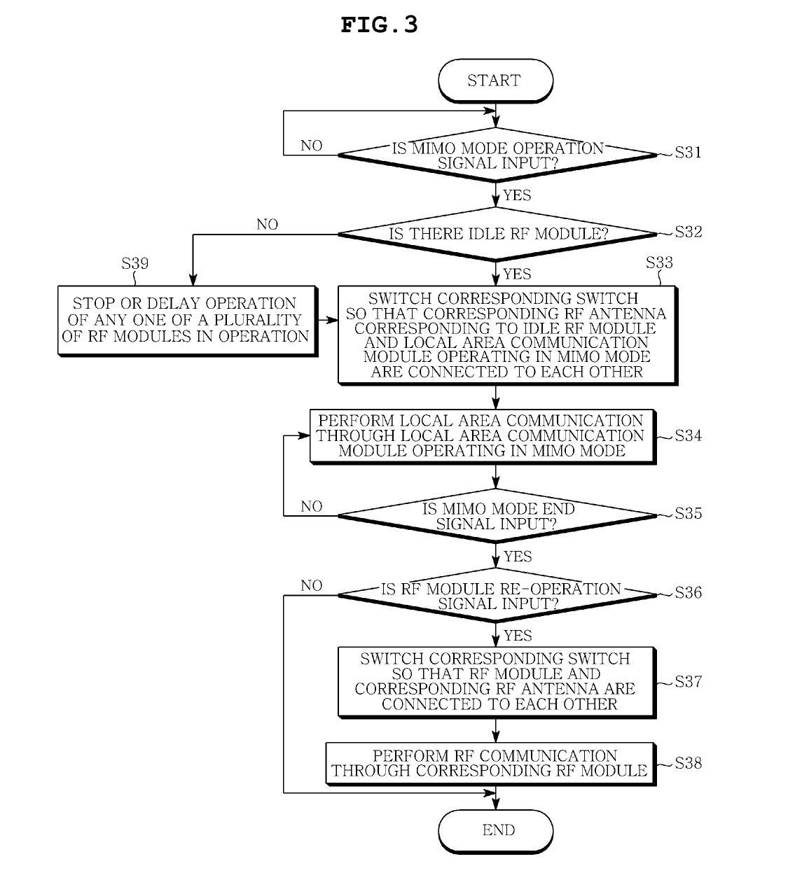

FIG. 3 is a flow chart showing a MIMO wireless communication method according to a preferred embodiment of the present invention.

Referring to FIG. 3, the control block 60 determines whether a MIMO mode operation signal is input (S31) and determines whether there is an idle RF module in a plurality of RF modules when the MIMO mode operation signal is input (S32).

When it is determined in the step (S32) that there is the idle RF module, the control block 60 switches a corresponding switch so that a corresponding RF antenna corresponding to the idle RF module and a local area communication module operating in a MIMO mode among a plurality of local area communication modules are connected to each other (S33).

For example, when the first RF module 11 is in an idle state, the control block 60 switches the first switch 41 so that a corresponding RF antenna 31 corresponding to the first RF module 11 and the local area communication module (for example, the third local area communication module 23) operating in the MIMO mode among the plurality of local area communication modules are connected to each other.

In addition, when the second RF module 12 is in an idle state, the control block 60 switches the second switch 42 so that a corresponding RF antenna 32 corresponding to the second RF module 12 and the local area communication module (for example, the third local area communication module 23) operating in the MIMO mode among the plurality of local area communication modules are connected to each other.

Then, local area communication is performed through the local area communication module operating in the MIMO mode by receiving a corresponding local area communication signal from the switched corresponding RF antenna (S34).

Meanwhile, when it is determined in the step (S32) that there is no idle RF module in the plurality of RF module, an operation of any one of the plurality of RF modules in operation is stopped or delayed (S39) and the step (S33) is then performed.

Next, the control block 60 determines whether a MIMO mode end signal is input (S35) and determines whether a RF module re-operation signal is input when the MIMO mode end signal is input (S36).

When it is determined in the step (S36) that the RF module re-operation signal is input, the control block 60 separates the local area communication module operating in the MIMO mode and a corresponding RF antenna from each other and switches a corresponding switch so that a corresponding RF antenna and a corresponding RF module are re-connected to each other (S37).

Then, RF communication is performed through a corresponding RF module by receiving a corresponding RF signal from the switched corresponding RF antenna (S38).

Here, when it is determined in the step (S35) that the MIMO mode end signal is not input, a process returns to the step (S34) and subsequent acts are performed.

In addition, when it is determined in the step (S36) that the RF module re-operation signal is not input, the MIMO wireless communication ends. As described above, when the MIMO mode is implemented in the local area communication module, it is implemented using the previously installed antenna (for example, the RF antenna) of other modules without additionally installing several local area communication dedicated antennas, thereby making it possible to maximize space utilization. In addition, a cost required for additionally installing the antennas, or the like, is not required, thereby making it possible to economically implement the MIMO.

As set forth above, according to the preferred embodiments of the present invention, the MIMO of the local area communication module is implemented using the previously installed antennas without adding the local area communication dedicated antenna, thereby making it possible to maximize space utilization and reduce a cost.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A multiple-input multiple-output (MIMO) wireless communication apparatus comprising:
a plurality of radio frequency (RF) modules each processing RF signals input through a corresponding RF antenna of a plurality of RF antennas;
a plurality of local area communication modules processing a local area communication signal input through a local area communication dedicated antenna and processing local area communication signals input through the plurality of RF antennas at the time of an MIMO mode operation;
a plurality of switches switched so that the plurality of RF modules and a corresponding RF antenna are connected to or separated from each other and the local area communication module operating at the time of the MIMO mode operation and a corresponding RF antenna are connected to or separated from each other; and
a control block determining whether there is an idle RF module in the plurality of RF modules at the time of the MIMO mode operation and switching a corresponding switch so that the local area communication module operating in the MIMO mode and a corresponding RF antenna corresponding to the idle RF module are connected to each other.

2. The MIMO wireless communication apparatus as set forth in claim 1, wherein the plurality of RF antennas include:
a first RF antenna connected to a corresponding RF module of the plurality of RF antennas or connected to the local area communication module operating in the MIMO mode among the plurality of local area communication modules; and
a second RF antenna connected to a corresponding RF module of the plurality of RF antennas or connected to the local area communication module operating in the MIMO mode among the plurality of local area communication modules.

3. The MIMO wireless communication apparatus as set forth in claim 1, wherein the plurality of RF modules include:
a first RF module processing a first RF signal input through a corresponding RF antenna of the plurality of RF antennas according to a first RF communication scheme; and
a second RF module processing a second RF signal input through a corresponding RF antenna of the plurality of RF antennas according to a second RF communication scheme.

4. The MIMO wireless communication apparatus as set forth in claim 1, wherein the plurality of local area communication modules include:
a first local area communication module processing a first local area communication signal input through the local area communication dedicated antenna according to a first local area communication scheme;
a second local area communication module processing a second local area communication signal input through the local area communication dedicated antenna according to a second local area communication scheme; and
a third local area communication module processing a third local area communication signal input through a corresponding RF antenna of the plurality of RF antennas connected thereto by a plurality of switches according to a control of the control block according to a third local area communication scheme.

5. The MIMO wireless communication apparatus as set forth in claim 4, wherein the first to third local area communication modules are any one of a wireless local area network (WLAN) communication module and a Bluetooth communication module.

6. The MIMO wireless communication apparatus as set forth in claim 4, further comprising a local area communication control module controlling each of the first and second local area communication modules so as to be operated according to a corresponding local area communication signal received through the local area communication dedicated antenna and controlling the third local area communication module so as to be operated in the MIMO mode according to the third local area communication signal received through a corresponding RF antenna of the plurality of RF antennas.

7. The MIMO wireless communication apparatus as set forth in claim 6, wherein the local area communication control module controls a switch (SW) for local area communication so that the local area communication dedicated antenna is connected to a corresponding local area communication module according to a communication scheme of a corresponding local area communication signal received through the local area communication dedicated antenna.

8. The MIMO wireless communication apparatus as set forth in claim 4, further comprising:
a first band pass filter (BPF) installed between the first local area communication module and the local area communication dedicated antenna or between the second local area communication module and the local area communication dedicated antenna and filtering the first local area communication signal or the second local area communication signal received through the local area communication dedicated antenna so as to have a frequency band used in a corresponding local area communication module;
a second BPF installed between the third local area communication module and one of the plurality of RF antennas and filtering the third local area communication signal received through a corresponding RF antenna so as to have a frequency band used in the third local area communication module;
a third BPF installed between the third local area communication module and the other of the plurality of RF antennas and filtering the third local area communication signal received through a corresponding RF antenna so as to have a frequency band used in the third local area communication module; and
a switch (SW) for local area communication performing the switching so that the local area communication dedicated antenna is connected to the first local area communication module or the second local area communication module according to a control of the local area communication control module.

9. The MIMO wireless communication apparatus as set forth in claim 1, wherein the plurality of switches include:
a first switch performing the switching so that one of the plurality of RF antennas is connected to a corresponding RF module of the plurality of RF modules or the local area communication module operating in the MIMO mode among the plurality of local area communication modules according to a control of the control block; and
a second switch performing the switching so that the other of the plurality of RF antennas is connected to a corresponding RF module of the plurality of RF modules or the local area communication module operating in the MIMO mode among the plurality of local area communication modules according to a control of the control block.

10. The MIMO wireless communication apparatus as set forth in claim 9, wherein the control block determines whether there is an idle RF module in the plurality of RF modules when a MIMO mode operation signal is input and controls the first and second switches so that the RF antenna corresponding to the idle RF module is connected to the local area communication module operating in the MIMO mode among the plurality of local area communication modules.

11. The MIMO wireless communication apparatus as set forth in claim 1, further comprising a plurality of antenna tuners having one ends each connected to the plurality of RF antennas and the other ends each connected to the plurality of switches, each tuning a frequency of the corresponding RF antenna connected to the local area communication module operating in the MIMO mode so as to be in a frequency band used in the local area communication module operating in the MIMO mode according to a control of the control block when any one of the plurality of RF antennas is connected to the local area communication module operating in the MIMO mode among the plurality of local area communication modules.

12. The MIMO wireless communication apparatus as set forth in claim 11, wherein the plurality of antenna tuners include:
a first antenna tuner tuning a frequency of one of corresponding RF antennas connected to the local area communication module operating in the MIMO mode among the plurality of local area communication modules so as to be in a frequency band used in the local area communication module operating in the MIMO mode; and
a second antenna tuner tuning a frequency of the other of corresponding RF antennas connected to the local area communication module operating in the MIMO mode among the plurality of local area communication modules so as to be in a frequency band used in the local area communication module operating in the MIMO mode.

13. The MIMO wireless communication apparatus as set forth in claim 12, wherein the control block controls the first antenna tuner to tune the frequency of one of the corresponding RF antennas connected to the local area communication module operating in the MIMO mode among the plurality of local area communication modules so as to be in the frequency band used in the local area communication module operating in the MIMO mode and controls the second antenna tuner to tune the frequency of the other of the corresponding RF antennas connected to the local area communication module operating in the MIMO mode among the plurality of local area communication modules so as to be in the frequency band used in the local area communication module operating in the MIMO mode.

14. A MIMO wireless communication method comprising:
(A) determining whether there is an idle RF module in a plurality of RF modules when a MIMO mode operation signal is input;
(B) switching a corresponding switch so that a corresponding RF antenna corresponding to the idle RF module and a local area communication module operating in a MIMO mode are connected to each other when there is the idle RF module; and
(C) performing local area communication through the local area communication module operating in the MIMO mode by receiving a corresponding local area communication signal from the switched corresponding RF antenna.

15. The MIMO wireless communication method as set forth in claim 14, further comprising (D) stopping or delaying an operation of any one of the plurality of RF modules when it is determined that there is no idle RF module in the plurality of RF module in step (A).

16. The MIMO wireless communication method as set forth in claim 15, further comprising, after step (D), (E) determining whether there is a RF module re-operation signal when a MIMO mode end signal is input, separating the local area communication module operating in the MIMO mode and a corresponding RF antenna from each other, and re-switching a corresponding switch so that the corresponding RF antenna and the corresponding RF module are connected to each other when there is the RF module re-operation signal; and (F) performing RF communication through the corresponding RF module by receiving a corresponding RF communication signal from the re-switched corresponding RF antenna.
